(19) United States
(12) Patent Application Publication
(10) Pub. No.: US 2008/0172895 A1
(43) Pub. Date: Jul. 24, 2008

(54) Material measuring device

(76) Inventor: Nick Lloyd, Worthing (GB)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/001,749

(22) Filed: Dec. 12, 2007

(30) Foreign Application Priority Data
Dec. 14, 2006 (GB) 0624947.8

(51) Int. Cl. G01B 5/02; G01B 3/00; B43L 7/00

(52) U.S. Cl. 33/443; 33/733; 33/701

(57) ABSTRACT

A material measuring device has a base and a support, in which the base is provided with a mounting system adapted to hold the support in one or more fixed positions over material to be measured, in which the base has a first end, and in which the fixed positions are spaced apart from the first end.

### BACKGROUND OF THE INVENTION

This invention relates to a material measuring device for use particularly, but not exclusively, to measure lengths of roofing material.

Flat roofs are commonly covered in strips of industrial roofing felt or the like, in order to make them weather proof. Such material is provided in large one-meter wide rolls, which is unrolled, cut to size and laid and fitted by hand.

At the roof edge specially cut pieces of the roofing material are laid over the edge, and a so-called “drip edge” is formed. A portion of the material is folded under itself and fixed in position, and the overlapped part is arranged against the wall. Such a construction ensures that the edge of the building is made weather proof, and that water does not run off the edge of the roof onto the supporting walls.

If the roof abuts up against a wall, specially cut pieces of the roofing material are placed against the wall and a so-called “up stand” is formed. Again, a portion of the material is folded under itself and fixed in position, and the overlapped part is arranged up against the wall. Such a constructions ensures that that part of the building is made weather proof.

Sometimes the edge of a roof is provided with an upstanding lip, and in such cases the pieces of roofing material are arranged up against the lip and over onto the wall. Again, an overlapped part is formed, and this is arranged against the wall.

As the roofing material is provided in rolls it cannot be readily folded in a direction perpendicular to the axis of the roll. As such, the drip edges and up stands must be formed from numerous short pieces of roll laid next to one another.

The portion of material which is folded under itself in these arrangements is commonly 3 inches (7.62 cm) in length. The total length of material which is used when a drip edge or up stand is formed is often 12 inches (30.48 cm) in length. However, sometimes this length of material is 14 inches (35.56 cm), 16 inches (40.64 cm), 18 inches (45.72 cm) or 20 inches (50.8 cm) in length, depending on requirements.

When these strips of material are used to form the drip edges or up stands they must be accurately cut from a roll of roofing felt. In addition, a score line has to be created 3 inches from the end to allow the material to be folded correctly. The roofing material is unrolled and laid flat, the measurements are made, and then the scores and cuts are performed with a knife and a straight support of some kind. This is a relatively simple task, but it is time consuming, in particular when a large number of pieces have to be cut and scored. In addition, the manual use of a meter wide straight support and a knife can be awkward.

The present invention is intended to overcome some of the above problems.

### SUMMARY OF THE INVENTION

Therefore, according to the present invention a material measuring device comprises a base and a support, in which the base is provided with mounting means adapted to hold the support in one or more fixed positions over material to be measured, in which the base has a first end, and in which the fixed positions are spaced apart from the first end.

Thus, an end of material to be cut can be laid adjacent the first end of the base, and the support can be set in a fixed position in order to provide a guide for cutting or scoring the material a predetermined distance from its end.

It will be appreciated that the invention can be used to measure out any material to be cut or scored, however in a preferred construction a second end of the base can be provided with roller support means adapted to carry a roll of material to be measured.

Preferably the mounting means can comprise a first part and a second part which are spaced apart, and each part can be adapted to hold one end of the support. The base can be adapted to support unrolled material to be measured between the first part and the second part. With this construction the support is held at both ends and can be used as a guide to cut or score material under it.

The first part and the second part of the mounting means can comprise any known mechanical mounting mechanism, but in a preferred construction they can comprise one or more spigots, and the support means can comprises an elongate member with apertures in each end adapted to receive the spigots. This is an advantageously simple and expedient construction.

The mounting means can be adapted to hold the support in a plurality of fixed positions over material to be measured, and the support can comprise a straight edge which can be disposed at separate pre-determined distances from the first edge of the base when the support is held in each of the plurality of fixed positions. As such the device can be specifically adapted to cut particular lengths of material as required.

As stated above, the device could be used to measure any material, but in a preferred embodiment it can be adapted to measure roofing material. In particular the roller support means can be adapted to carry a roll of one meter wide roofing material, and the base can be adapted to support a one meter wide strip of unrolled roofing material between the first part and the second part of the mounting means.

In addition, the support can comprises a 4 inch (10.16 cm) wide flat panel with a straight edge at both sides, and it can be mountable on the mounting means such that one or both straight edges are disposable 3 inches from the first end, 12 inches from the first end, 14 inches from the first end, 16 inches from the first end, 18 inches from the first end and 20 inches from the first end.

The support is flexible in that either straight edge can be employed in most of these positions. For example when a first straight edge is disposed at the 12 inch position, the other will be disposed at the 16 inch position, but the first straight edge can also be positioned at the 16 inch position when the other is disposed at the 20 inch position. In addition, the support can be lifted off the mounting means and turned around if desired.

Preferably the base can be provided with five slots which extend between the first part and the second part of the mounting means and which are parallel with the first end of the base. The slots can be aligned with the straight edges when they are disposed 12, 14, 16, 18 and 20 inches from the first end. These allow a cutting tool to pass through the material without damaging the base, and they also provide a form of guide for the cutting tool.

The support can be provided with a handle to make it easy to move it between fixed positions.

### BRIEF DESCRIPTION OF THE DRAWINGS

The invention can be performed in various ways but one embodiment will now be described by way of example and with reference to the accompanying drawing in which:

FIG. 1 is a perspective view of a material measuring device according to the present invention.

### DETAILED DESCRIPTION

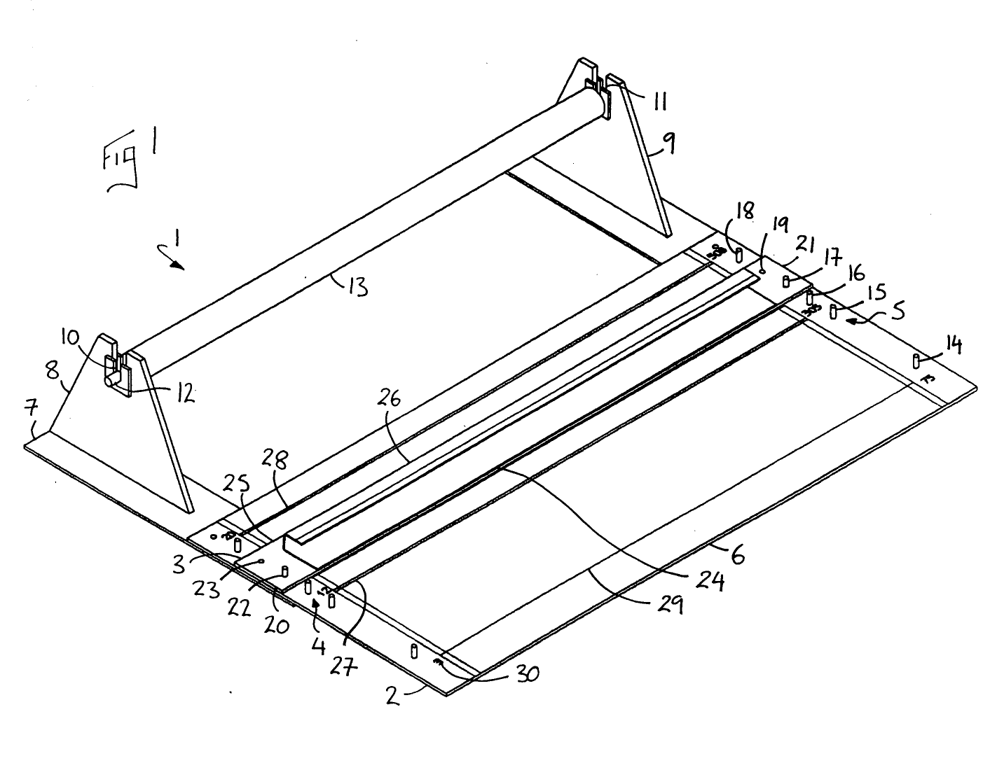

As shown in FIG. 1 a material measuring device 1 comprises a base 2 and a support 3. The base 2 is provided with mounting means, in the form of first row of spigots or pegs 4 and second row of spigots 5, which are adapted to hold the support 3 in one or more fixed positions over material to be measured (not shown). The base 2 has a first end 6, and the fixed positions are spaced apart from the first end 6, as described further below.

A second end 7 of the base 2 is provided with roller support means, in the form of first upright 8 and second upright 9. The uprights 8 and 9 are provided with sockets 10 and 11 respectively, which rotationally support the ends (only one of which 12 is visible) of a roller 13. The roller 13 does not form a part of the device 1, rather material to be cut (not shown) comes in a roll wrapped around a roller like roller 13, and the whole roll is supported on the uprights 8 and 9. The roll is arranged such that material to be cut can be drawn from the bottom of the roll towards the first end 6 of the base 2. The device is intended for measuring lengths of roofing felt, and such material comes in one meter wide rolls. Therefore, the uprights 8 and 9 are spaced apart to accommodate such a one meter wide roll.

As is clear from FIG. 1 the first row of spigots 4 and the second row of spigots 5 are spaced apart from one another, and sufficiently so to accommodate a one meter wide length of roofing felt between them. In the preferred embodiment each row comprises five spigots, which allow the support 3 to be fixed in multiple positions, as described further below. The spigots of each row 4 and 5 are aligned with each other such that five pairs 14, 15, 16, 17, and 18 are formed.

The preferred support 3 comprises an elongate panel with two apertures 19 in each end 20 and 21, which are adapted to receive the spigots of each row 4 and 5. The apertures 19 of each end 20 and 21 of the support 3 are aligned with each other such that two pairs 22 and 23 are formed. Therefore, the support 3 can be fixed in multiple positions over roofing felt to be cut (not shown) which can be arranged on the base 2, under the support 3.

In the preferred embodiment the support 3 is 4 inches wide and has a straight edge at both sides 24 and 25. It can be mounted on the spigots of each row 4 and 5 such that one or both straight edges 24 and 25 are disposable 3, 12, 14, 16, 18 and 20 inches from the first end 6, as explained further below. The support 3 is provided with an elongate handle 26.

In the preferred embodiment the base 2 is provided with five slots which extend between the first and second rows of spigots 4 and 5 at 12, 14, 16, 18 and 20 inches from the first end 6. Only slots 27 and 28 are visible in FIG. 1. The base 2 is also provided with a score line 29 at 3 inches from the first end 6.

Reference numerals 30 are provided on the base 2 adjacent each slot (27, 28) and the score line 29 to indicate their distance from the first end 6. The numerals 30 down one side are in inches, and the numerals 30 down the other side are in millimeters.

In use a roll of roofing felt (not shown) is mounted on the uprights 8 and 9, such that the material can be drawn from the bottom of the roll. The support 3 is removed from the base 2, and the material is drawn from the roll and laid on the base 2 until its end is level with the first end 6.

The support 3 is then mounted on the spigots of each row 4 and 5 so either edge 24 or 25 can be used as a support for either scoring or cutting the roofing material.

As described above, when a drip edge or an up stand is created a 3 inch portion of the roofing material is always folded back to form a double layer, and this is facilitated by creating a score line 3 inches from the end of the material. The piece of material to be used to form the drip edge or up stand must also be cut to a particular length, usually 12 inches, but it can be any length.

Therefore, with the end of roofing material laid adjacent the first end 6, the user places the support 3 on the first pair of spigots 14, so one of the straight edges 24 or 25 is level with the score line 29. The user then runs a bladed along the straight edge to create the score.

If the piece of roofing material is to be 12 inches in length the user then places the support 3 on the second or third pair of spigots 15 or 16, such that either straight edge 24 or 25 is level with the 12 inch cut line 27. The user then runs a blade along the straight edge to create the score.

If the piece of roofing material is to be 12 inches in length the user then places the support 3 on the second or third pair of spigots 15 or 16, such that either straight edge 24 or 25 is level with the 12 inch cut line 27. The user then runs a blade along the straight edge to cut the roofing material. The slot allows the blade to pass through the material being cut without damaging the base.

If the piece of roofing material is to be 14, 16, 18 or 20 inches in length, then instead of arranging a straight edge 24 or 25 adjacent the 12 inch cut line 27, the user arranges the support 3 on the first and second row of spigots 4 and 5 such that one of the straight edges 24 or 25 is adjacent the particular cut line required.

In some instances it may be necessary to have two or more score lines formed in the piece of material, for example if the material must turn through 90 degrees at a number of points to overlie an upstanding lip. If this is required then once a first score has been created at three inches, the material can be pulled further off the roll until the position of the next score is aligned with the score line 29, and the next score can be created. This process can be repeated if necessary.

It will be appreciated that the support 3 is flexible in that either straight edge 24 or 25 can be employed in most of the above described positions. For example when straight edge 24 is disposed at the 12 inch position, the other straight edge 25 will be disposed at the 16 inch position, but the straight edge 24 can also be positioned at the 16 inch position when the other straight edge 25 is disposed at the 20 inch position. In addition, the support 3 can be lifted off the first and second rows of spigots 4 and 5 and turned around if desired.

In some positions only one of the pairs of spigots 14, 15, 16, 17 or 18 are received in one of the pairs of apertures 22 and 23 on the support 3, and in other positions two of the pairs of spigots 14, 15, 16, 17 or 18 are received in both pairs of apertures 22 and 23 on the support 3. It will be appreciated that the two pairs of apertures 22 and 23 allow the 4 inch wide support 3 to be mounted in positions only two inches apart.

In use spacers can be placed over the spigots so the support 3 is spaced above the base 2. The spacers could be individual rings of material slotted over the spigots, or they could comprise a panel with apertures therein, which overlies the whole of the first or second rows of spigots 4 or 5. if this is done then the material to be cut can be slotted under the support 3, so different cuts or scores can be made without moving the support 3. The spacers could also be integrally formed on the spigots.

The embodiment described above can be altered without departing from the scope of the claims. For example, while a simple and expedient mounting means is shown in the embodiment described above, it will be appreciated that there are many known ways the same end could be achieved. For example, in one alternative embodiment the support is mounted on a track and can slide up and down therein.

In addition, while the above described embodiment relates specifically to the cutting of roofing felt, it will be appreciated that the device 1 could be used for measuring lengths of any material, and the locations of the spigots and the slots can be chosen according to requirements.

Therefore, a simple measuring device is provided which facilitates the ready scoring and cutting of roofing material for the formation of drip edges and up stands.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A material measuring device comprising a base and a support, in which the base is provided with mounting means adapted to hold the support in one or more fixed positions over material to be measured, in which the base has a first end, and in which the fixed positions are spaced apart from the first end.

2. The material measuring device according to claim 1 in which a second end of the base is provided with roller support means adapted to carry a roll of material to be measured.

3. The material measuring device according to claim 2 in which the mounting means comprise a first part and a second part which are spaced apart, in which each part is adapted to hold one end of the support, and in which the base is adapted to support unrolled material to be measured between the first part and the second part.

4. The material measuring device according to claim 3 in which the first part and the second part of the mounting means comprises one or more spigots, and in which the support means comprises an elongate member with apertures in each end adapted to receive the spigots.

5. The material measuring device according to claim 4 in which the mounting means is adapted to hold the support in a plurality of fixed positions over material to be measured, in which the support comprises a straight edge, and in which the straight edge is disposed at separate pre-determined distances from the first ends of the base when the support is held in each of the plurality of fixed positions.

6. The material measuring device according to claim 5 in which the device is adapted to measure roofing material, in which the roller support means is adapted to carry a roll of one meter wide roofing material, and in which the base is adapted to support a one meter wide strip of unrolled roofing material between the first part and the second part of the mounting means.

7. The material measuring device according to claim 6 in which the support comprises a 4 inch (10.16 cm) wide flat panel with a straight edge at both sides, in which the support is mountable on the mounting means such that one or both straight edges are disposable 3 inches (7.62 cm) from the first end and 12 inches (30.48 cm) from the first end.

8. The material measuring device according to claim 7 in which the support is mountable on the mounting means such that one or both straight edges are also disposable 14 inches (35.56 cm) from the first end, 16 inches (40.64 cm) from the first end, 18 inches (45.72 cm) from the first end and 20 inches (50.8 cm) from the first end.

9. The material measuring device according to claim 8 in which the base is provided with five slots which extend between the first part and the second part of the mounting means and which are parallel with the first end of the base, and which are aligned with the straight edge when it is disposed 12 inches (30.48 cm) from the first end, 14 inches (35.56 cm) from the first end, 16 inches (40.64 cm) from the first end, 18 inches from the first end and 20 inches (50.8 cm) from the first end.

10. The material measuring device according to claim 9 in which the support is provided with a handle.

11. A method for measuring roofing felt comprising:
placing a roll of roofing felt at a first end of a measuring base, the base having a first score line located approximately three inches from a second end of the base;
unrolling the roofing felt and placing an end thereof level with the second base end;
placing a support on the base adjacent the second end and scoring the roofing felt along the first score line; and
placing the support on the base at a location thereon closer to the first end and scoring the roofing felt along a second score line.

12. The method as set forth in claim 11 further comprising unrolling an additional three inches after scoring the first three inch piece of roofing felt and then scoring the additional approximately three inches.
